(19) United States
(12) Patent Application Publication
(10) Pub. No.: US 2014/0072353 A1
(43) Pub. Date: Mar. 13, 2014

(54) FUSING APPARATUS AND METHOD

(71) Applicant: Samsung Electronics Co., Ltd., Suwon-si (KR)

(72) Inventors: Dong-earn KIM, Seoul (KR); Dong-ouk KIM, Pyeongtaek-si (KR); Ha-jin KIM, Hwaseong-si (KR); Sung-hoon PARK, Seoul (KR); Min-jong BAE, Yongin-si (KR); Yoon-chul SON, Hwaseong-si (KR); Sang-eui LEE, Hwaseong-si (KR); Kun-mo CHU, Seoul (KR); In-taek HAN, Seoul (KR)

(73) Assignee: Samsung Electronics Co., Ltd., Suwon-Si (KR)

(21) Appl. No.: 13/923,472

(22) Filed: Jun. 21, 2013

(30) Foreign Application Priority Data
Sep. 11, 2012 (KR) 10-2012-0100655

(51) Int. Cl. G03G 15/20

(52) U.S. Cl. CPC G03G 15/2053
USPC 399/329

(57) ABSTRACT

A fusing apparatus including a heating unit including a heater having a substantially flat shape; a nip forming unit which faces the heating unit and forms a fusing nip with the heating unit; and a driving unit which moves the heating unit to alternately repeat a forward motion whereby the heating unit moves forward in a moving direction of the recording medium, when the fusing nip is formed, and a returning motion whereby the heating unit moves backward in a direction opposite to the moving direction of the recording medium, when the fusing nip is released.

### CROSS-REFERENCE TO RELATED APPLICATIONS

This application claims priority to Korean Patent Application No. 10-2012-0100655, filed on Sep. 11, 2012, and all the benefits accruing therefrom under 35 U.S.C. §119, the disclosure of which is incorporated herein in its entirety by reference.

### BACKGROUND

1. Field

Provided are an apparatus and method of fusing a toner image formed on a recording medium by applying heat and pressure to the toner image.

2. Description of the Related Art

Image forming apparatuses using an electrophotographic method, for example, laser printers, form an electrostatic latent image on an image receptor, form a visible toner image on the image receptor by supplying toner to the electrostatic latent image, transfer the visible toner image to a recording medium, for example, a sheet of paper, and fuse the transferred toner image on the recording medium. The toner is prepared by adding various functional additives, such as a coloring agent, to a base resin. A fusing process includes applying heat and/or pressure to the toner.

A fusing apparatus used in the fusing process includes a heating member including a heat source, and a pressing member that is engaged with the heating member to form a fusing nip. The heat source may be, for example, a film heater. The heating member may be a roller type element or a belt type element.

### SUMMARY

Provided are a non-rotary fusing apparatus and method for stably supplying current to a heat source (a heater).

Additional aspects will be set forth in part in the description which follows and, in part, will be apparent from the description, or may be learned by practice of the presented embodiments.

According to an aspect of the present invention, a fusing apparatus for fusing a toner image formed on a recording medium by applying heat and pressure to the toner image includes: a heating unit including a heater having a substantially flat shape; a nip forming unit which faces the heating unit and forms a fusing nip with the heating unit; and a driving unit which moves the heating unit to alternately repeat a forward motion whereby the heating unit moves forward in a moving direction of the recording medium, when the fusing nip is formed, and a returning motion whereby the heating unit moves backward in a direction opposite to the moving direction of the recording medium, when the fusing nip is released.

The nip forming unit may be disconnected from the heating unit and be in a fixed position during the forward and returning motions of the heating unit. The nip forming unit may include a belt which is circulated. The nip forming unit may include a platen positioned inside the belt and facing the heater.

The nip forming unit may be connected to the heating unit and move forward and backward together with the heating unit in the forward and returning motions.

The fusing apparatus may further include a bracket connected to a lateral portion of the nip forming unit and the heating unit,

The nip forming unit may be in a fixed position with respect to the bracket, and the heating unit may be moveable with respect to the bracket in an elevation direction away from and toward the nip forming unit.

The fusing apparatus may further include an elevation guide extending from the nip forming unit in an elevation direction of the heating unit such that the heating unit 100 is guided and supported by the elevating guide to elevate from and lower to the nip forming unit.

The driving unit may include a guidance member including a first trajectory corresponding to the forward motion and a second trajectory corresponding to the returning motion of the heating unit; a first arm which rotates about a rotation axis as a rotation center; and a second arm which is moveably engaged with the guidance member, fixedly connected to the heating unit, and coupled to the first arm so as to rotate in a radial direction of the first arm.

The second arm may move along the first trajectory such that the heating unit moves forward at a constant speed.

The driving unit includes a first return spring which applies an elastic force to the heating unit in a direction in which the heating unit moves backward; a first cam including: a forward cam trajectory which moves the heating unit in a direction opposite to the direction of the elastic force of the first return spring to move the heating unit forward in the moving direction of the recording medium, through a first rotation angle of the first cam, and a backward cam trajectory which moves the heating unit backward in the direction opposite to the moving direction of the recording medium, due to the elastic force of the first return spring, through a second rotation angle of the first cam; a second return spring which applies an elastic force to the heating unit in a direction away from the nip forming unit; and a second cam including: a press cam trajectory which moves the heating unit toward the nip forming unit in a direction opposite to the direction of the elastic force of the second return spring so as to maintain the fusing nip, through a first rotation angle of the second cam, and a release cam trajectory which moves the heating unit away from the nip forming unit to release the fusing nip, due to the elastic force of the second return spring, through a second rotation angle of the second cam. The first rotation angles and the second rotation angles may be substantially the same.

The backward cam trajectory of the first cam may include first and second stop cam trajectories which maintain the heating unit at a constant position, at a beginning and an end of the backward cam trajectory.

The heater may include a resistance heating layer including a base polymer, and an electrically conductive filler dispersed in the base polymer; a member which supports the resistance heating layer; and a current supplying electrode unit which supplies current to the resistance heating layer. The current may flow in the resistance heating layer in a direction crossing the moving direction of the recording medium.

The current supplying electrode unit may include a pair of electrodes elongated in a direction crossing the moving direction of the recoding medium, and spaced apart from each other in the moving direction of the recording medium.

The heater may further include a release layer which is on the resistance heating layer and is an outermost layer and faces the nip forming unit.

The heater may further include an elastic layer disposed between the resistance heating layer and the release layer.

According to another aspect of the present invention, a fusing method includes preparing a heating unit including a heater which generates heat and has a substantially flat shape, and a nip forming unit including a nip former having a substantially flat shape; forming a fusing nip between the heater and the nip forming unit by reducing a gap between the heating unit and the nip forming unit; fusing a toner image on a recording medium passing through the fusing nip in a moving direction, by applying heat and pressure to the toner image while moving the heating unit in a forward motion in the moving direction; releasing the fusing nip by increasing the gap between the heating unit and the nip forming unit; and moving the heating unit in a backward motion in a direction opposite to the moving direction. The preparing, the forming, the fusing, the releasing, and the moving are repeated.

The heater may include a resistance heating layer including a base polymer, and an electrically conductive filler disposed in the base polymer.

The applying heat and pressure to the toner image may include supplying current flowing in the resistance heating layer in the moving direction of the recording medium.

The supplying current flowing in the resistance heating layer may further include arranging a pair of electrodes elongated in a direction crossing the moving direction of the recording medium, and spaced apart from each other in the moving direction of the recording medium; and supplying the current to the pair of electrodes.

### BRIEF DESCRIPTION OF THE DRAWINGS

The above and/or other aspects of the present invention will become apparent and more readily appreciated from the following description of the embodiments, taken in conjunction with the accompanying drawings of which:

FIG. 1 is a schematic structural diagram of a fusing apparatus according to an embodiment of the present invention;

FIG. 2 is a set of diagrams for explaining a fusing method of the fusing apparatus of FIG. 1, according to an embodiment of the present invention;

FIG. 3 is a schematic structural diagram of a fusing apparatus including a nip forming unit that does not move, according to another embodiment of the present invention;

FIG. 4 is a sectional view of a heating unit, according to an embodiment of the present invention;

FIG. 5 is a bottom view of the heating unit shown in FIG. 4, according to an embodiment of the present invention;

FIG. 6 is a cross-sectional view of a heating unit, according to another embodiment of the present invention;

FIG. 7 is a schematic structural diagram of a driving unit, according to an embodiment of the present invention;

FIG. 8 is a schematic plan view of the driving unit shown in FIG. 7, according to an embodiment of the present invention;

FIG. 9 is a diagram of a first cam trajectory in which a heating unit moves forward at a constant speed, according to an embodiment of the present invention;

FIG. 10 is an exploded perspective view of a fusing apparatus in which a nip forming unit and a heating unit move together forward/backward, according to an embodiment of the present invention;

FIG. 11 is a longitudinal cross-sectional view of the fusing apparatus of FIG. 10, according to an embodiment of the present invention;

FIG. 12 is a schematic side view of a driving unit, according to another embodiment of the present invention;

FIG. 13 shows a fusing method using the driving unit shown in FIG. 12, according to another embodiment of the present invention; and

FIG. 14 is a timing chart of first and second cam trajectories, according to another embodiment of the present invention.

### DETAILED DESCRIPTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically and/or electrically connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

A fusing apparatus including a rotary heating member includes a brush type electrode as an electrode for supplying current to a heat source. When the brush type electrode is used, stably supplying current to the heat source is more difficult and an electrical spark is more likely to occur then when a fixed type electrode is used. In addition, the brush type electrode is undesirably exposed to an outside of the fusing apparatus.

Also, installing a sensor for temperature control, which slidably contacts a heating member, on a fusing nip, is difficult. Thus, precisely controlling a temperature at the fusing nip is difficult. In addition, although it is most desirable that only the fusing nip generates heat, a rotary heating member generates heat overall, in general. Thus, obtaining high energy efficiency of a fusing apparatus is difficult and reducing the total amount of carbon dioxide emission is not easy.

In addition, there is a need to secure a relatively wide fusing nip in order to increase fusing properties of a fusing apparatus. To this end, a method of increasing pressure at a fusing nip may be used. However, the method is disadvantageous for securing the durability of the fusing apparatus including the fusing nip. A method of increasing a diameter of a heating member and a pressing member is also disadvantageous for increasing thermal efficiency of the fusing apparatus. In addition, a method of reducing hardness of the heating member and the pressing member requires a relatively large amount of material such as rubber or sponge, and thus, reducing emission of volatile organic compounds (“VOCs”) is also difficult.

Hereinafter, a fusing apparatus and a fusing method will be described with regard to embodiments of the invention with reference to the attached drawings.

A fusing apparatus may be used in, for example, an image forming apparatus employing an electrophotographic method. The fusing apparatus may fuse a toner image formed on a recording medium P, to the recording medium P by applying heat and pressure to the toner image such as by using an electrophotographic process.

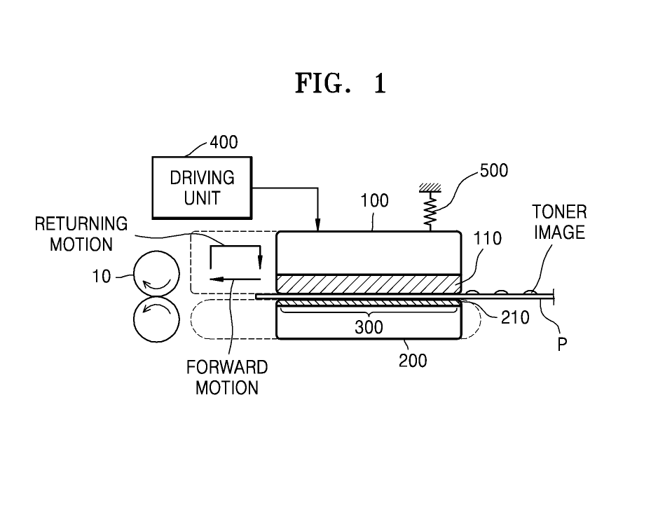

FIG. 1 is a schematic structural diagram of a fusing apparatus according to an embodiment of the present invention. Referring to FIG. 1, the fusing apparatus includes a heating unit 100 including a heater 110 having a substantially flat or planar shape, and a nip forming unit 200 that faces the heater 110 to form a fusing nip 300. The nip forming unit 200 includes a nip former 210 that faces the heater 110 and has a substantially flat shape.

The fusing apparatus according to the present embodiment is configured in such a way that the heater 110 and the nip former 210 may each have a substantially flat shape and the heating unit 100 may reciprocate in a moving direction of the recording medium P rather than being rotated. That is, a driving unit 400 drives the heating unit 100 to repeat a forward motion in the moving direction of the recording medium P when the fusing nip 300 is formed, and a returning or backward motion in an direction opposite to the moving direction when the fusing nip 300 is released. The driving unit 400 may move the heating unit 100 together with the nip forming unit 200, forward and backward.

The heating unit 100 may be pressed toward the nip forming unit 200 by a pressing member 500. In one embodiment, for example, the pressing member 500 may be a compressive coil spring. Although not shown in FIG. 1, the pressing member 500 may be a plate spring that is elongated to extend in the moving direction of the heating unit 100. A moving roller 10 moves the recording medium P that passes through the fusing nip 300.

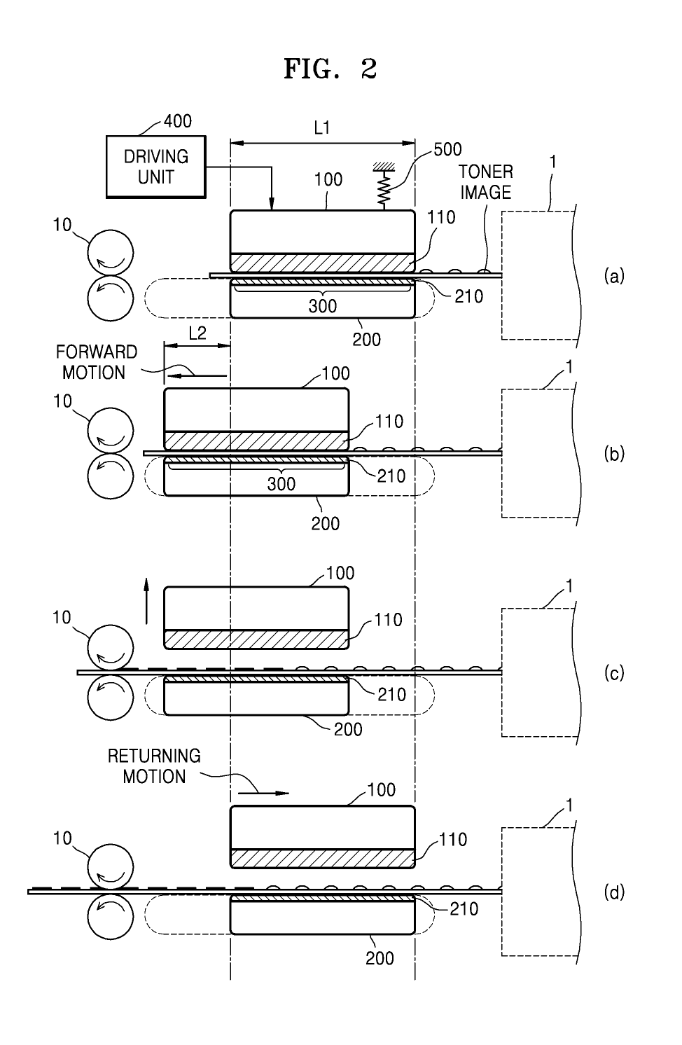

FIG. 2 is a set of diagrams for explaining a fusing method executed by the fusing apparatus of FIG. 1, according to an embodiment of the present invention. As shown in a) of FIG. 2, the heating unit 100 and the nip forming unit 200 are engaged with each other to form the fusing nip 300. The recording medium P, which is discharged from a printing unit 1 that forms a toner image on the recording medium P by using, for example, an electrophotographic process, is positioned on the fusing nip 300. The toner image is formed on a surface of the recording medium P, which faces the heater 110.

As shown in (b) of FIG. 2, the heating unit 100 engaged with the nip forming unit 200 moves forward in the moving direction of the recording medium P with the formed fusing nip 300. A speed of the forward motion of the engaged heating and nip forming units 100 and 200 is substantially the same as a moving speed of the recording medium P. That is, the engaged heating and nip forming units 100 and 200 essentially move along with the recording medium P, while the recording medium P is at the fusing nip 300. During the forward motion, the toner image is melted at the fusing nip 300 due to thermal energy and compressive force which are transferred from the heater 110 and/or the nip forming unit 200, and the toner image is thereby fused on the recording medium P.

When the forward motion of the engaged heating and nip forming units 100 and 200 is finished, the heating unit 100 becomes disengaged and spaced apart from the nip forming unit 200 to release the fusing nip 300, as shown in (c) of FIG. 2. Then, as shown in (d) of FIG. 2, the heating unit 100 returns in a direction opposite to the moving direction of the recording medium P.

In one embodiment, for example, when a distance by which the recording medium P of the fusing nip 300 moves in the moving direction is L1 and a distance by which the heating unit 100 engaged with the nip forming unit 200 moves forward is L2, an equation L1=m×L2 may be satisfied. Here, ‘m’ may be a positive integer or positive natural number. While the heating unit 100 or the heating unit 100 engaged with the nip forming unit 200 move forward and return once (a first fusing period), the recording medium P moves by as much as a length L1 of the fusing nip 300. Accordingly, a length of a fusing region for the first fusing period corresponds to L1.

Since the moving speed of the recording medium P is constant, as ‘m’ is increased, the width of the fusing nip 300 may be increased, which means that the size of the fusing apparatus is increased. Thus, ‘m’ may be appropriately determined in consideration of the size of a space occupied by the fusing apparatus in, for example, an image forming apparatus. In one embodiment, for example, ‘m’ may be determined as 3 or so. Where ‘m’ is 3 or so, during the forward motion, the recording medium P moves together with the engaged heating and nip forming units 100 and 200 by as much as L2, and during the returning motion, the recording medium P moves by as much as 2×L2. Accordingly, the toner image may be fused without an interval (a non-fusing region) between a first fusing region and a subsequent second fusing region.

In order to reduce or effectively prevent a non-fusing region from being formed between a fusing region for a first fusing period and a fusing region for a subsequent second fusing period, a preceding fusing region and the subsequent fusing region may slightly overlap each other. To this end, a speed of the forward motion may be slightly greater than a speed of the returning motion.

As described above, by repeating the forward motion and the returning motion, the toner image formed on the recording medium P discharged from the printing unit 1 may be fused on the recording medium P.

According to the aforementioned embodiment of the present invention, the nip forming unit 200 moves forward and returns together with the heating unit 100. However, the present invention is not limited thereto. A distance or length of the nip forming unit 200 taken in the moving direction of the recording medium P may be equal to or greater than the sum of the distance L2 by which the heating unit 100 moves forward and the length L1 of the fusing nip 300, as indicated by dotted lines of FIGS. 1 and 2. The length L1 of the fusing nip 300 may essentially be a length of the heating unit 100 taken in the moving direction. Here, the nip forming unit 200 may not move (e.g., be static or have a set position), as indicated by the dotted lines.

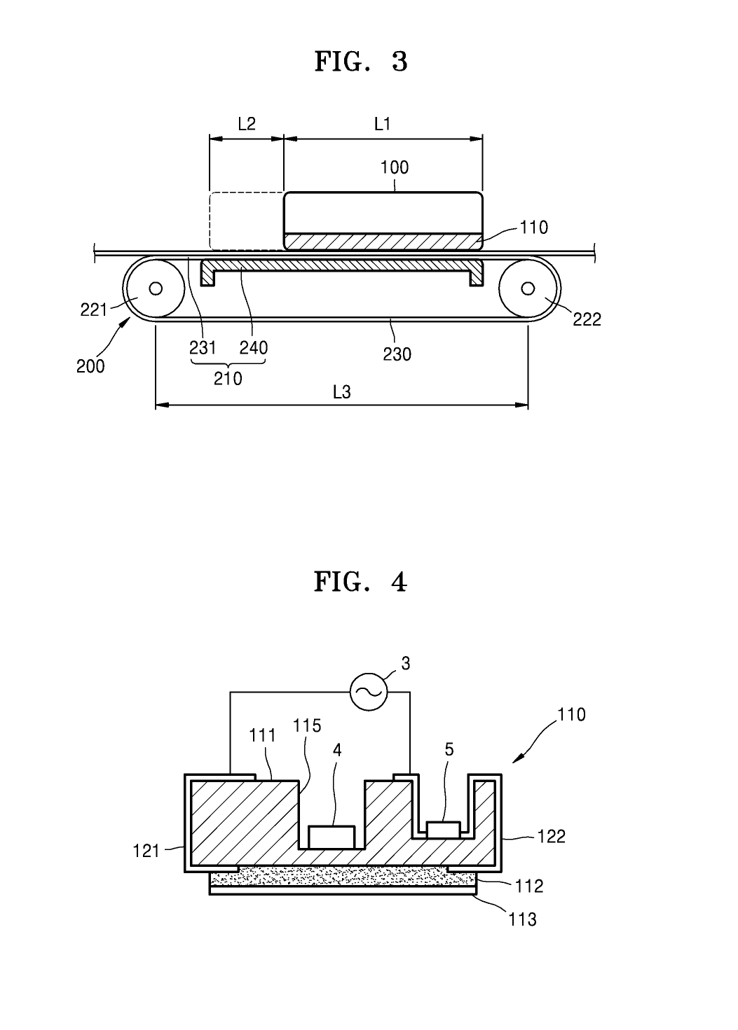

As an example, FIG. 3 is a schematic structural diagram of a fusing apparatus including a nip forming unit 200 that does not move, according to another embodiment of the present invention. Referring to FIG. 3, a belt 230 that is circulated by supporting rollers 221 and 222 may be used as the nip forming unit 200. When a distance L3 between the supporting rollers 221 and 22 or a distance L3 by which the belt 230 circulates is equal to or greater than a total distance by which the heating unit 100 moves, for example, L1+L2, the nip forming unit 200 may be located at a fixed position rather than moving in the forward and returning directions. Where the nip forming unit 200 is in a fixed position while the heating unit 100 moves with respect to the nip forming unit 200, a platen 240 may be provided at an inside of a loop formed by the belt 230 to face the heater 110 and to reduce or effectively prevent the belt 230 from sagging. The platen 240 and a portion 231 of the belt 230, which is positioned above the platen 240, form a nip former 210.

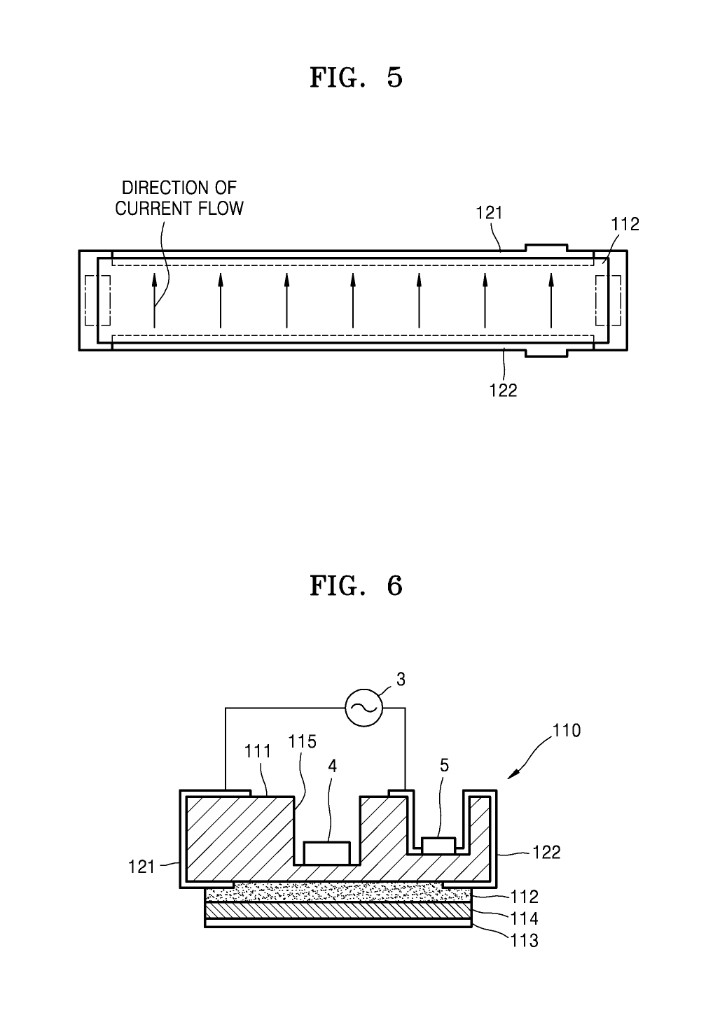

FIG. 4 is a cross-sectional view of the heating unit 100, according to an embodiment of the present invention. FIG. 5 is a bottom view of the heating unit 100, according to an embodiment of the present invention. Referring to FIG. 4, the heater 110 may include a base 111, a resistance heating layer 112 and a release layer 113. The base 111 may support the resistance heating layer 112 and may include, for example, polyimide, polyimide-amide, a polymer-based material such as fluoropolymer, a metallic material such as stainless steel, nickel (Ni), copper (Cu) or brass, or a ceramic material. When the base 111 includes a conductive material, an insulating layer (not shown) may be disposed between the base 111 and the resistance heating layer 112. A thickness and shape of the base 111 taken in a cross-sectional direction may be determined as long as the base 111 may have appropriate mechanical strength for withstanding a compressive force for forming the fusing nip 300.

The resistance heating layer 112 may include a base polymer and an electrically conductive filler that is dispersed in the base polymer. The base polymer is not particularly limited as long as the base polymer may have heat resistance for withstanding a fusing temperature. In one embodiment, for example, the base polymer may be a polymer having high heat resistance, such as a silicone polymer, polyimide, polyimide-amide or fluoropolymer. The fluoropolymer may include, for example, polytetrafluoroethylenes (“PTFE”), fluorinated polyetherketones (“PEEK”), perfluoroalkoxy (“PFA”), fluorinated ethylene propylene (“FEP”) or the like. In one embodiment, for example, the base polymer may be any one of the above-mentioned polymers or may be a blend or copolymer of at least two of the above-mentioned polymers. The resistance heating layer 112 may be elastic. The rigidity of the base polymer may be adjusted according to desired elasticity of the resistance heating layer 112.

One or two types of electrically conductive fillers may be dispersed in a base polymer. The electrically conductive fillers may include a metallic filler such as a metallic particle, or a carbonaceous filler. Examples of the carbonaceous filler may include, but are not limited to, a carbon nanotube (“CNT”), carbon black, carbon nanofiber, graphene, expanded graphite, graphite nano platelet, graphite oxide (“GO”) or the like.

The electrically conductive fillers are dispersed in the base polymer and form an electrically conductive network. In one embodiment, for example, when the CNT is used, a conductor or resistor having electrical conductivity of about 10⁻⁴ Siemen per meter (S/m) to about 100 Siemens per meter (S/m) may be prepared according to the amount of the CNT. Since the CNT has a very low density while still having electrical conductivity corresponding to the electrical conductivity of metal, the CNT has heat capacity (where heat capacity=density×specific heat), which is about 3 times to about 4 times lower than a general resistor material. This means that, when the CNT is used as an electrically conductive filler, a temperature of the resistance heating layer 112 may change very quickly. Thus, a time taken to change an image forming apparatus from a standby state to a print state may be reduced by using the resistance heating layer 112 including an electrically conductive filler, thereby quickly beginning to perform a first or initial printing. In addition, in the standby state, the heater 110 may not nearly have to be preheated, thereby reducing overall power consumption.

When the carbonaceous filler, for example, the CNT is used, the content of the CNT may be appropriately determined between a minimum content for forming a significant electrically conductive network and a maximum content for reducing or effectively preventing a reduction in the mechanical strength of the resistance heating layer 112. In one embodiment, for example, the content of the CNT may be appropriately determined between about 1 part by weight to about 50 parts by weight based on 100 parts by weight of the resistance heating layer 112 including the CNT. In order to increase the heat resistance of the resistance heating layer 112, the resistance heating layer 112 may include, for example, a metal oxide particle such as Fe₂O₃, and Al₂O₃. The content of the metal oxide particle may be equal to or greater than, for example, about 5 parts by weight based on 100 parts by weight of the resistance heating layer 112.

During a fusing process, while toner on the recording medium P is melted, offset may occur whereby toner is undesirably adhered to the heater 110. The offset may cause printing failure whereby a printed image is partially omitted on the recording medium P, and may cause a jam whereby the recording medium P, which deviates from the fusing nip 300, is adhered to a surface of the heater 110 rather than being separated from the heater 110. The release layer 113 may include a polymer layer having excellent releasing properties in order to reduce or effectively prevent the toner from being adhered to the heater 110. In one embodiment, for example, the release layer 113 may include a silicone polymer or fluoropolymers. The fluoropolymers may include, for example, polyperfluoroethers, fluorinated polyethers, fluorinated polyimides, PEEK, fluorinated polyamides, fluorinated polyesters or the like. The release layer 113 may include any one of the above-mentioned polymers or may be a blend or copolymer of at least two of the above-mentioned polymers.

Referring to FIGS. 4 and 5, a current supplying electrode unit for supplying current to the resistance heating layer 112 may be disposed on the heater 110. In the illustrated embodiment, for example, the current supplying electrode unit may include a pair of electrodes 121 and 122. The electrodes 121 and 122 are physically and/or electrically connected to a power supply 3.

As indicated as dashed dotted lines of FIG. 5, the electrodes 121 and 122 may be elongated to extend in the moving direction of the recording medium P. The electrodes 121 and 122 may be spaced apart from each other in a longitudinal direction of the resistance heating layer 112 that crosses the moving direction of the recording medium P. The moving direction of the recording medium P may also be referred to as a width direction or transverse direction of the resistance heating layer 112.

The heating temperature and heating rate of the resistance heating layer 112 are dependent upon a geometric dimension thereof such as a cross-sectional thickness or a length of the resistance heating layer 112, and the physical properties thereof such as the specific heat or electrical conductivity of the resistance heating layer 112. As resistance of the resistance heating layer 112 is further reduced, the heater 110 is heated with higher efficiency and at higher speed. In general, resistance R of a resistor material is proportional to the length of the resistor material and is inversely proportional to the cross-sectional area or thickness and electrical conductivity of the resistor material. In order to reduce resistance of the resistance heating layer 112, the electrical conductivity of the resistance heating layer 112 may be increased. The electrical conductivity of the resistance heating layer 112 may be increased by increasing the content of conductive fillers, increasing the alignment properties of the conductive fillers and/or adjusting the dispersity of the conductive fillers. However, when the content of the conductive fillers in the resistance heating layer 112 is increased, the mechanical and/or physical properties thereof may deteriorate, thereby reducing the lifetime of the heater 110. Accordingly, there is a limit to which the content of the conductive fillers is increased.

In the fusing apparatus according to the present embodiment, the current supplying electrode unit for forming a current flow in the moving direction of the recording medium P, that is, the width direction of the resistance heating layer 112 is disposed on the resistance heating layer 112 such that current may flow via in a shortest possible path in the resistance heating layer 112. To this end, as shown in FIGS. 4 and 5, the current supplying electrode unit includes the electrodes 121 and 122 that are elongated to extend in a longitudinal direction of the resistance heating layer 112. The electrodes 121 and 122 may also be spaced apart from each other in the moving direction of the recording medium P. Thus, current may flow in the width direction of the resistance heating layer 112, and thus, may have a very short electrical path. Accordingly, a current loss may be reduced, thereby increasing the temperature of the heater 110 at high speed.

In the fusing apparatus according to the present embodiment, the heating unit 100 reciprocates in forward and reverse directions rather than being rotated. Thus, the electrodes 121 and 122 and the power supply 3 may be connected to each other by a fixed connecting structure, for example, a connector or the like. Accordingly, current may be stably supplied to the resistance heating layer 112 and there is minimal risk such as an electrical spark.

Referring to FIG. 4, the base 111 includes a first concave portion 115, and a temperature sensor 4 for controlling the temperature of the fusing nip 300 is disposed in the concave portion 115. That is, the temperature sensor 4 may be fixedly disposed very close to the fusing nip 300 with respect to the overall cross-sectional thickness of the base 111, thereby effectively and precisely controlling the temperature of the fusing nip 300. In addition, the base 111 may include a second concave portion, and a thermo-limiter, for example, a thermostat 5 may also be disposed adjacent and close to the fusing nip 300, thereby effectively addressing product liability (“PL”) concerns.

The heater 110 is one component of the fusing apparatus that forms the fusing nip 300. Only the heater 110 is heated in the fusing apparatus. Thus, the fusing apparatus according to the present embodiment may have high energy efficiency and low total amount of carbon dioxide emission, compared with a typical rotary fusing apparatus. Moreover, the temperature of the heater 110 may be quickly increased, thereby increasing a first print out time (“FPOT”) of an image forming apparatus. In addition, compared with the typical rotary fusing apparatus, the overall volume of a heating element for generating heat may be reduced.

Since the volume of the heating element, that is, the resistance heating layer 112 which still has the same fusing performance as that of the typical rotary fusing apparatus, is reduced compared with the typical rotary fusing apparatus, electrical conductivity required for the resistance heating layer 112 may be reduced, and accordingly, overall power consumption may be reduced.

Table 1 below shows simulation results of electrical conductivity required for a flat fusing apparatus according to the present embodiment in which electrodes are arranged spaced apart in a width direction of the resistance heating layer 112 (which is a moving direction of a recording medium) and electrical conductivity required for a rotary fusing apparatus in which electrodes are arranged in a longitudinal direction of the resistance heating layer 112, when the same power and voltage are used. As shown in Table 1, it may be confirmed that the electrical conductivity required for the flat fusing apparatus according to the present embodiment is about 1/20 of and much lower than the electrical conductivity required for the rotary fusing apparatus. Based on this result, power for fusing may be reduced. In addition, the fusing apparatus according to the present embodiment may also be easily applied to a case where 110 volts (V) power is used.

TABLE 1

| | Flat fusing | | Flat fusing | | Rotary fusing | |
|---|---|---|---|---|---|---|
| | apparatus | | apparatus | | apparatus | |
| Power (watts, W) | 800 | | 1300 | | 1300 | |
| Voltage (V) | 220 | 110 | 220 | 110 | 220 | 110 |
| Required electrical | 7.9 | 31.5 | 12.8 | 51.2 | 263.0 | 1052.0 |
| conductivity (S/m) | | | | | | |
| Interval between | 3 | 3 | 3 | 3 | 235 | 235 |
| electrodes (milli- | | | | | | |
| meters, mm) | | | | | | |
| Thickness of | 300 | 300 | 300 | 300 | 300 | 300 |
| resistance heating | | | | | | |
| layer (micro- | | | | | | |
| meters, μm) | | | | | | |

As described above, the low required electrical conductivity means that the amount of electrically conductive fillers dispersed in the resistance heating layer 112 may be reduced. That is, the amount of the electrically conductive fillers, in particular, CNTs may be reduced, and thus, manufacturing cost of the fusing apparatus may be reduced. In general, CNTs reduce the adhesion between the resistance heating layer 112 and the release layer 113. Accordingly, the adhesion between the resistance heating layer 112 and the release layer 113 may be reinforced by reducing the amount of the CNTs, thereby increasing the durability of the heating unit 100.

Since the heater 110 has a substantially flat shape, the fusing nip 300 may have a relatively large planar area. Thus, a sufficient dwell time of the recording medium P may be ensured during a fusing process, and accordingly, temperature and pressure conditions for fusing may be applied to the toner image on the recording medium P.

FIG. 6 is a cross-sectional view of a heating unit 100, according to another embodiment of the present invention. Referring to FIG. 6, an elastic layer 114 may be disposed between the resistance heating layer 112 and the release layer 113. Due to the elastic layer 114, the size or the effective area of the fusing nip 300 may be further increased. In addition, the elastic layer 114 may include the same polymer as that of the release layer 113 and/or the resistance heating layer 112, thereby increasing the adhesion between the elastic layer 114 and the release layer 113 and/or the resistance heating layer 112. In addition, an amount of voltage that can be withstood by the heater 110 may be increased and the risk of electric shock due to leakage current may be reduced.

Hereinafter, the driving unit 400 that drives the heating unit 100 to repeat a forward motion and a returning motion will be described with regard to embodiments of the invention with reference to the attached drawings.

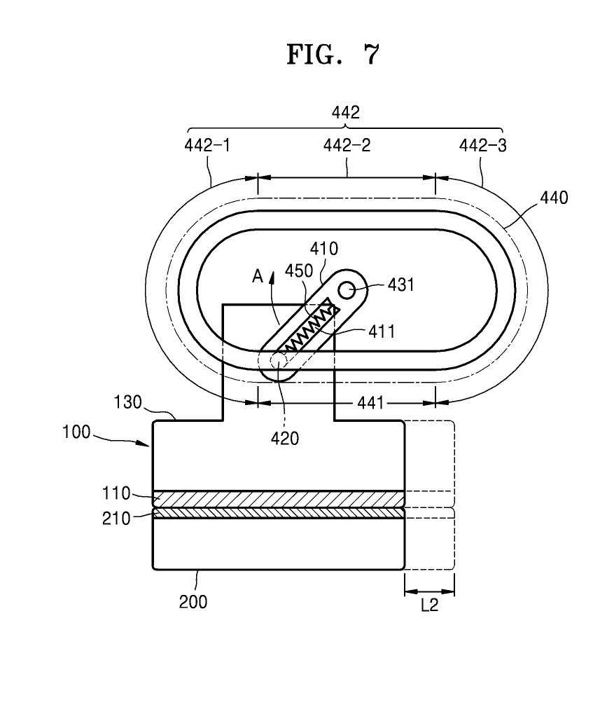

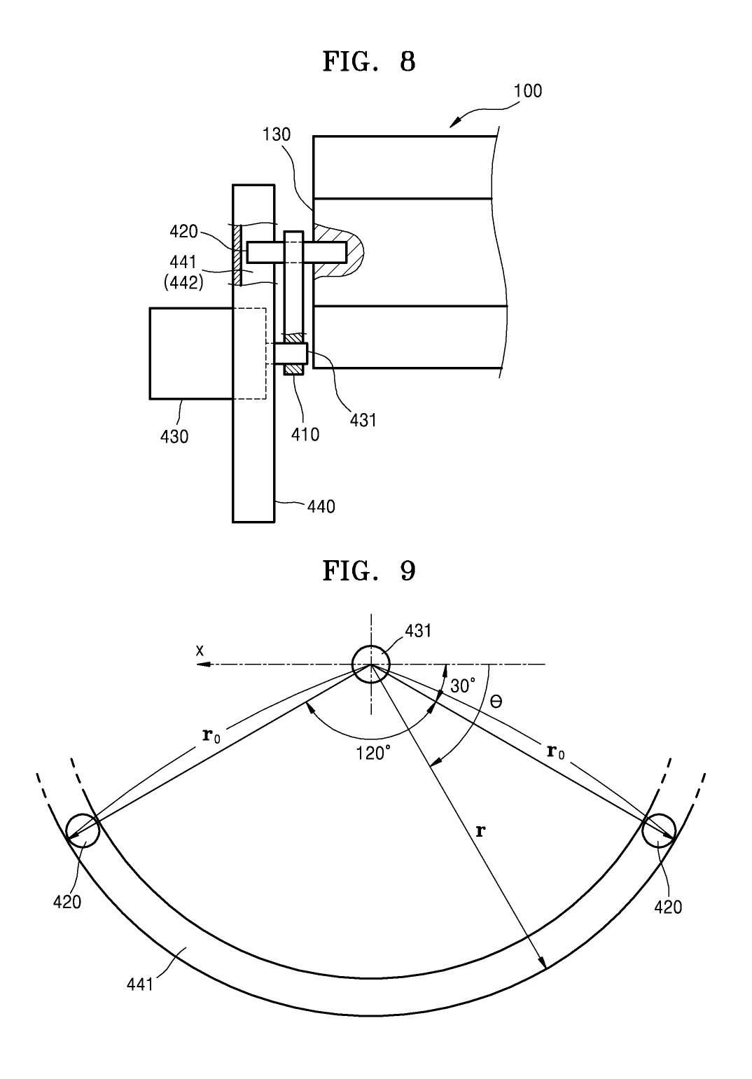

FIG. 7 is a schematic structural diagram of the driving unit 400, according to an embodiment of the present invention. FIG. 8 is a schematic plan view of the driving unit 400 shown in FIG. 7, according to an embodiment of the present invention. Referring to FIGS. 7 and 8, the driving unit 400 may include a first arm 410 that is rotatable, a second arm 420 connected to the first arm 410, and a guidance member 440 that guides a moving path of the second arm 420 with rotation of the first arm 410. The first arm 410 is fixed to, for example, at a rotation axis 431 of a rotation driver 430 and is rotated by the rotation driver 430. The rotation driver 430 may be a rotation motor provided in a fusing apparatus. Alternatively, the rotation driver 430 may be a power transferring member such as a gear or the like connected to a driver of an image forming apparatus.

The second arm 420 is fixed to the heating unit 100. In one embodiment, for example, the second arm 420 may be provided on a holder 130 for supporting the heater 110. A first end of the second arm 420 may be fixed to the holder 130, and an opposing second end of the second arm 420 may be engaged with the guidance member 440. The second end of the second arm 420 may protrude into a recess defined in the guidance member 440, such that the second end travels along the recess. The second arm 420 may protrude from a lateral portion of the holder 130. The second arm 420 is connected to the first arm 410. The second art 420 may pass through an opening defined in the first arm 410. The second arm 420 is connected to the first arm 410 so as to move in a radial direction of the first arm 410 when the first arm 410 rotates. In one embodiment, for example, the first arm 410 may include a slot 411 extended in the radial direction of the first arm 410, and the second arm 420 may be inserted into the slot 411. In an embodiment of forming the first arm 410, the first arm may be cut to form the slot 411.

The guidance member 440 includes first and second trajectories 441 and 442. The first and second trajectories 441 and 442 may be defined along the closed loop recess defined in the guidance member 440. The first trajectory 441 and the second trajectory 442 correspond to the forward motion and the returning motion of the heating unit 100, respectively. The first trajectory 441 may be substantially in parallel to the moving direction of the recording medium P. The second trajectory 442 may include an away section 442-1 in which the heating unit 100 becomes spaced apart from the nip forming unit 200 in order to release the fusing nip 300, a backward section 442-2 in which the heating unit 100 moves in an opposite direction to the moving direction of the recording medium P, and an approach section 442-3 in which the heating unit 100 approaches toward the nip forming unit 200 in order to form the fusing nip 300 again.

A pressing member 450 may be disposed in the slot 411. The pressing member 450 is, for example, a compressive spring and applies an elastic force in a direction in which the second arm 420 comes into contact with external walls of the first and second trajectories 441 and 442. In the away section 442-1 and the approach section 442-3, a length of the pressing member 450 increase from a length in the first trajectory 441 and the backward section 442-2, respectively, due to the force of the pressing member 450 urging the second arm 420 in contact with the external walls of the first and second trajectories 441 and 442.

Referring to FIGS. 2, 7, and 8, if ‘m’ is, for example, 3, when the first arm 410 rotates once in a direction A of FIG. 7, the first trajectory 441 guides the second arm 420 such that the heating unit 100 may move forward by as much as a distance L2 correspondingly to a 120-degree rotation of the first arm 410, and the second trajectory 442 guides the second arm 420 such that the heating unit 100 may be spaced apart from the nip forming unit 200 (e.g., 442-1), may move backward in an opposite direction to the moving direction of the recording medium P by as much as the distance L2 (e.g., 442-2), and then may approach toward the nip forming unit 200 again (e.g., 442-3) to form the fusing nip 300 correspondingly to 240-degree rotation of the first arm 410.

In general, when a rotational motion is simply converted into a linear motion, a linear speed is changed according to a rotation angle. Since the recording medium P moves at a constant speed, the heating unit 100 needs to be also moved at a constant speed. To this end, the first trajectory 441 may be configured to have a variable diameter.

Referring to FIG. 9, when a distance from the rotation axis 431 to the first trajectory 441 (e.g., normal to the first trajectory 441) is ‘r’, a rotation angle of the first arm 410 is θ, an angular speed of the first arm 410 is ‘ω’, and a time is ‘t’, a moving distance x of the heating unit 100 during the rotation of the first arm 410 may be represented by x=r(θ)cos(θ).

A moving speed Vx and acceleration Ax of the heating unit 100 are respectively represented by

$${V}_{x} = \frac{d x}{d t} = \frac{d theta}{d t} \frac{d x}{d theta} = ω ( {r ( θ )}^{′} cos θ - r ( θ ) sin θ ) = const$$

$$and$$

$${A}_{x} = \frac{{d}^{2} x}{d {t}^{2}} = \frac{{d}^{2} θ}{d {t}^{2}} \frac{{d}^{2} x}{d {θ}^{2}} = {ω}^{2} ( {r ( θ )}^{″} cos θ - 2 {r ( θ )}^{′} θ - r ( θ ) sin θ ) .$$

When Ax=0, ‘r’ is represented by

$$r ( θ ) = \frac{a θ + b}{cos θ} . \qquad ( Conditional Expression 1 )$$

When

$$r ( \frac{π}{6} ) - r ( \frac{5 π}{6} ) - {r}_{0}$$

as a boundary condition is inserted into Conditional Expression 1 above,

$$\begin{matrix}a = - {r}_{0} \frac{3 \sqrt{3}}{2 π} , & b = {r}_{0} \frac{3 \sqrt{3}}{4} are obtained .\end{matrix} \qquad ( Conditional Expression 2 )$$

The first trajectory 441 may be configured in such a way that a distance ‘r’ may satisfy Conditional Expressions 1 and 2 above, and thus, the heating unit 100 may move forward at a constant speed.

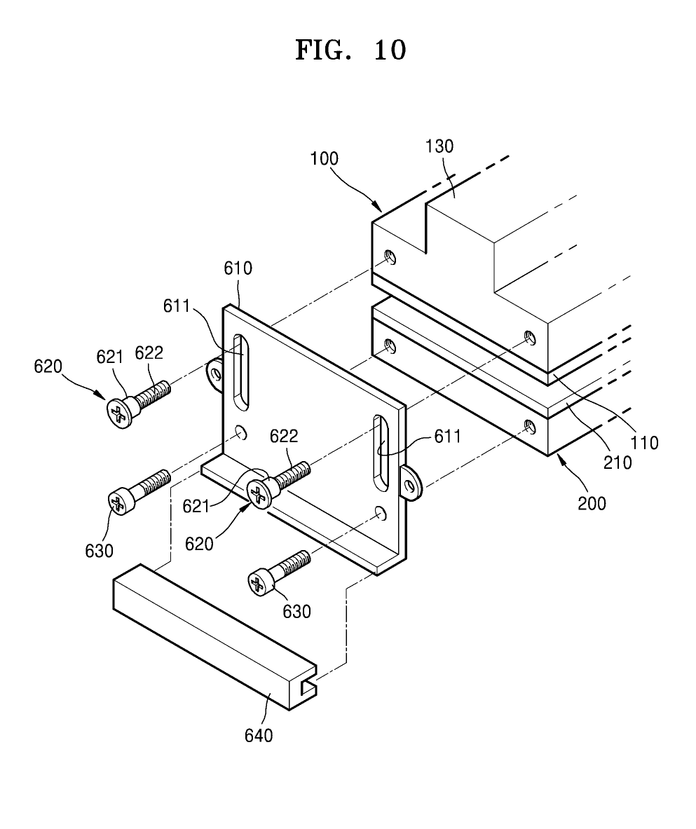

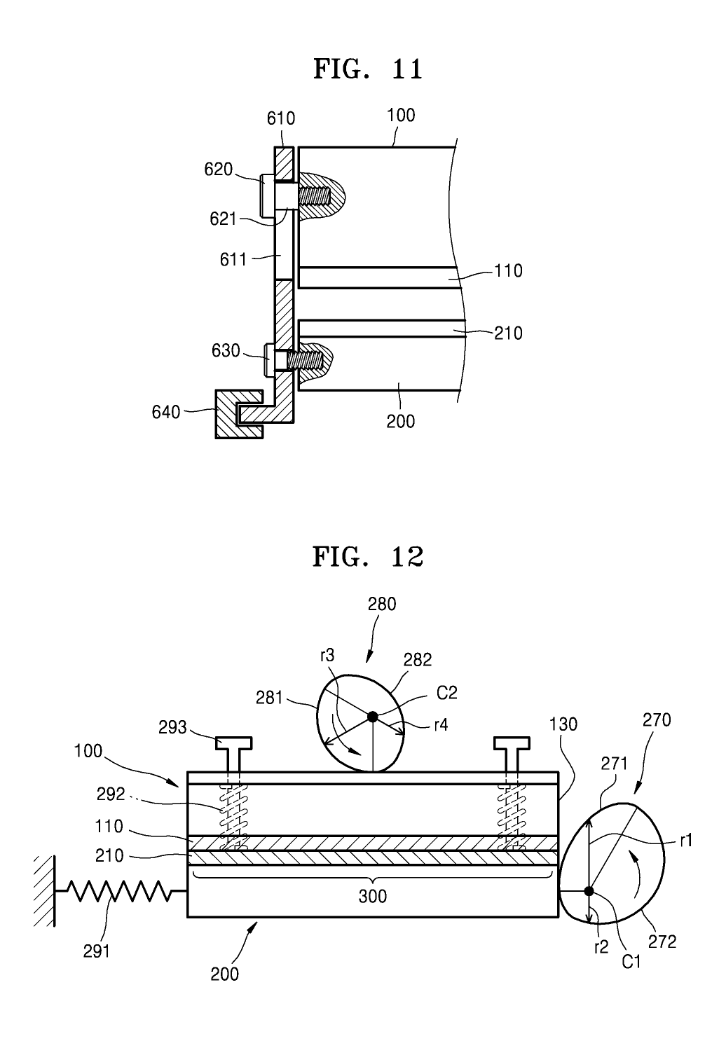

FIG. 10 is an exploded perspective view of a fusing apparatus in which the nip forming unit 200 and the heating unit 100 move together forward and backward, according to an embodiment of the present invention. FIG. 11 is a longitudinal cross-sectional view of the fusing apparatus of FIG. 10, according to an embodiment of the present invention. Referring to FIGS. 10 and 11, the heating unit 100 and the nip forming unit 200 are connected to each other by a bracket 610. The bracket 610 is fixedly coupled to one lateral portion of the nip forming unit 200, or to two opposing lateral portions of the nip forming unit 200. Only one lateral portion is shown in FIG. 10 and FIG. 11 for illustrative purposes. The heating unit 100 may be supported by the bracket 610 so as to elevate from and lower to the nip forming unit 200, in an elevating direction. In the illustrated embodiment, for example, guide grooves 611 are defined elongated in the elevating direction is formed in the bracket 610. In addition, guide pins 620 each of which includes a guide portion 621 inserted into a respective guide groove 611 and a coupler 622 coupled to the holder 130, may be coupled to the heating unit 100. The bracket 610 may be fixed to the nip forming unit 200 by coupling members 630, for example, screws.

According to the above-described structure, when the heating unit 100 moves forward, the nip forming unit 200 moves forward together with the heating unit 100 according to drive of the driving unit 400 (refer to FIGS. 7 and 8), as shown in (b) of FIG. 2. When the heating unit 100 returns, the heating unit 100 guided by the guide grooves 611 defined in the bracket 610 to firstly elevate from and secondly lower to the nip forming unit 200, with heating unit 100 and the nip forming unit 200 moving backward, as shown in (c) and (d) of FIG. 2. The nip forming unit 200 may be supported by a forward/backward guide member (not shown) such that the nip forming unit 200 may also stably move forward/backward along a straight path of forward motion when the heating unit 100 elevates and lowers. Referring to FIG. 10 and FIG. 11, for example, the forward/backward guide member may be embodied as a rail 640 that is elongated to extend in the moving direction of the recording medium P and support the bracket 610. A portion of the bracket 610 may be received in a slot (unnumbered) defined in the rail 640 as shown by the dashed dotted lines in FIG. 10 and elongated in the moving direction, such that the bracket 610 moves along the slot in the moving direction.

FIG. 12 is a side view of a driving unit 400, according to another embodiment of the present invention. FIG. 12 shows a first cam 270 for moving the heating unit 100 forward and backward and a second cam 280 for elevating and lowering the heating unit 100 from and to the nip forming unit 200.

In one embodiment, for example, when the heating unit 100 is elastically biased by a first return spring 291 in a direction in which the heating unit 100 moves backward, the first cam 270 may contact or be engaged with a rear side of the heating unit 100, which corresponds to the backward motion. In contrast, when the heating unit 100 is elastically biased in a direction in which the heating unit 100 moves forward, the first cam 270 may contact a front side of the heating unit 100, which corresponds to the forward motion.

The first cam 270 includes a forward cam trajectory 271 for moving the heating unit 100 forward and a backward cam trajectory 272 for moving the heating unit 100 backward. In the illustrated embodiment, for example, as shown in FIG. 12, when the first cam 270 rotates counterclockwise, a distance r1 from a rotational center C1 of the forward cam trajectory 271 is further increased as a rotation angle is increased. In order for the heating unit 100 to move forward at a constant linear speed, a distance r1 from the rotational center C1 of the forward cam trajectory 271 may be determined to satisfy Conditional Expressions 1 and 2 below. In order for the heating unit 100 to move backward due to the elastic force of the first return spring 291, a distance r2 from a rotation center C1 of the backward cam trajectory 272 is gradually reduced as a rotation angle is increased. According to this structure, the heating unit 100 may move forward and backward by rotating the first cam 270.

A second return spring 292 applies an elastic force in a direction in which the heating unit 100 and the nip forming unit 200 become spaced apart from each other. The second return spring 292 may include, for example, a compressive coil spring. In the illustrated embodiment, for example, an elevating guide 293 that is elongated to extend in an elevating direction of the heating unit 100 may be provided in the nip forming unit 200. The heating unit 100 may be guided and supported by the elevating guide 293 to elevate from and lower to the nip forming unit 200.

The second cam 280 changes a stroke for pressing the heating unit 100 such that the heating unit 100 may elevate from and lower to the nip forming unit 200 to form and release the fusing nip 300. The second cam 280 includes a press cam trajectory 281 corresponding to the forward cam trajectory 271 of the first cam 270, and a release cam trajectory 282 corresponding to the backward cam trajectory 272 of the first cam 270. A distance r3 from a rotation center C2 of the press cam trajectory 281 may be determined to apply an appropriate compressive force to form the fusing nip 300 with the heating unit 100 and the nip forming unit 200. Since a constant compressive force needs to be applied to maintain the fusing nip 300 during the forward motion of the heating unit 100, the distance r3 from the rotation center C2 of the press cam trajectory 281 is constant. A distance r4 from a rotation center C2 of the release cam trajectory 282 may be determined such that the heating unit 100 may be spaced apart from the nip forming unit 200 so as not to apply a compressive force such that the fusing nip 300 is not formed.

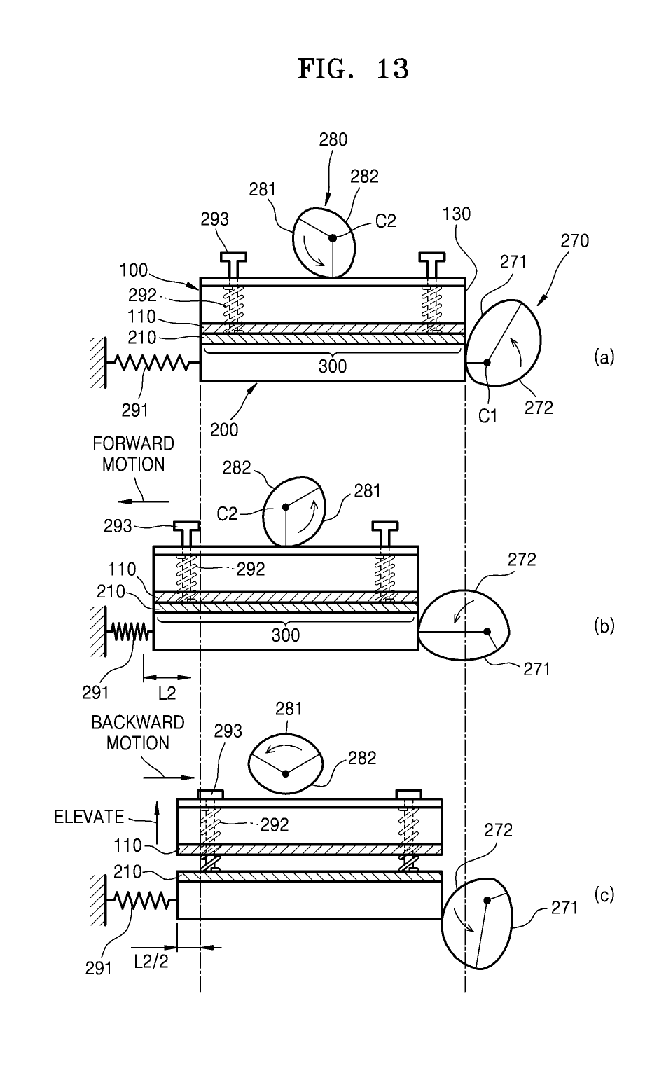

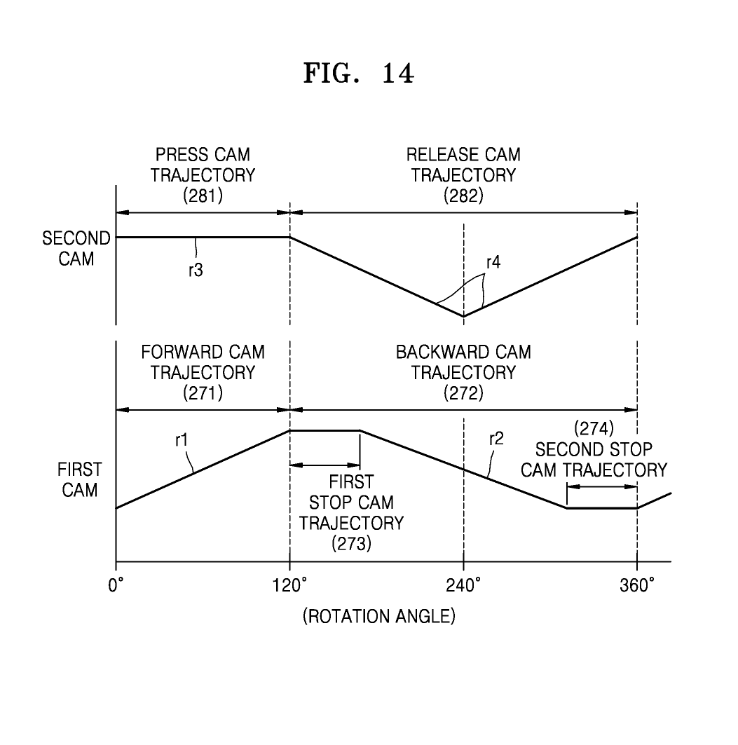

Operations (a) to (c) of FIG. 13 show embodiments where the heating unit 100 and the nip forming unit 200 are driven when each of the forward cam trajectory 271 and the press cam trajectory 281 has a rotational range within about 120 degrees. Operation (a) of FIG. 13 shows a point in time when the heating unit 100 begins to move forward. The forward cam trajectory 271 of the first cam 270 contacts the nip forming unit 200 and the press cam trajectory 281 of the second cam 280 contacts the heating unit 100. Due to the press cam trajectory 281, the heating unit 100 may move towards the nip forming unit 200 and may contact the nip forming unit 200. Thus, the fusing nip 300 is formed between the heating unit 100 and the nip forming unit 200.

From the state shown in (a) of FIG. 13, the first and second cams 270 and 280 rotate by as much as 120 degrees. Since a distance from the rotation center C1 of the forward cam trajectory 271 of the first cam 270 is gradually increased, the heating unit 100 and the nip forming unit 200 move forward along the moving direction (e.g., to the left) together by a distance L2, as shown in (b) of FIG. 13. While the heating unit 100 and the nip forming unit 200 move forward, a distance from the rotation center C2 of the press cam trajectory 281 of the second cam 280 is not changed, and the fusing nip 300 is maintained while the second cam 280 rotates by as much as 120 degrees.

When the forward motion is completed, the first and second cams 270 and 280 begin to rotate, the release cam trajectory 282 faces the heating unit 100 and the heating unit 100 begins to be spaced apart from the nip forming unit 200 due to the elastic force of the second return spring 292. As the first cam 270 rotates, the heating unit 100 and the nip forming unit 200 are guided by the backward cam trajectory 272 to move backward and opposite to the moving direction due to the elastic force of the first return spring 291. When the first and second cams 270 and 280 rotate by as much as 120 degrees, the heating unit 100 and the nip forming unit 200 move backward by as much as about L2/2, for example, as shown in (c) of FIG. 13.

Then, when the first and second cams 270 and 280 further rotate by as much as 120 degrees, the heating unit 100 and the nip forming unit 200 returns to a state, like in (a) of FIG. 13.

FIG. 14 is a timing chart showing changes in distances r1, r2, r3, and r4 from the rotation centers C1 and C2 of the forward and backward cam trajectories 271 and 272 of the first cam 270 and the press and release cam trajectories 281 and 282 of the second cam 280 along with rotation of the first and second cams 270 and 280, respectively. At a point in time when the forward motion is changed to the backward motion, the heating unit 100 needs to be spaced apart from the nip forming unit 200. To this end, as shown in FIG. 14, a first stop cam trajectory 273 of which a distance from a rotation center C1 is not changed may be provided in a predetermined angular section from a point in time when the backward cam trajectory 272 begins. The heating unit 100 does not move backward and is maintained in a stop state by the first stop cam trajectory 273 until the fusing nip 300 is completely released.

In addition, at a point in time when the backward motion is changed to the forward motion, the heating unit 100 and the nip forming unit 200 move towards and are pressed against each other to completely form the fusing nip 300. To this end, a second stop cam trajectory 274 of which a distance from a rotation center C1 is not changed may be provided in a predetermined angular section before the backward cam trajectory 272 is terminated. The heating unit 100 does not move forward and backward and is maintained in a stop state by the second stop cam trajectory 274 until the fusing nip 300 is completely formed.

According to the above-described structure, a fusing apparatus may be configured in such a way that the heating unit 100 and the nip forming unit 200 may move forward and backward together essentially as a single unit.

It should be understood that the embodiments described herein should be considered in a descriptive sense only and not for purposes of limitation. Descriptions of features or aspects within each embodiment should typically be considered as available for other similar features or aspects in other embodiments.

What is claimed is:

1. A fusing apparatus for fusing a toner image on a recording medium by applying heat and pressure to the toner image, the fusing apparatus comprising:
a heating unit comprising a heater having a substantially flat shape;
a nip forming unit which faces the heating unit and forms a fusing nip with the heating unit; and
a driving unit which moves the heating unit to alternately repeat
a forward motion whereby the heating unit moves forward in a moving direction of the recording medium, when the fusing nip is formed, and
a returning motion whereby the heating unit moves backward in a direction opposite to the moving direction of the recording medium, when the fusing nip is released.

2. The fusing apparatus of claim 1, wherein the nip forming unit is disconnected from the heating unit and is in a fixed position during the forward and returning motions of the heating unit.

3. The fusing apparatus of claim 2, wherein the nip forming unit comprises a belt which rotates.

4. The fusing apparatus of claim 3, wherein the nip forming unit further comprises a platen positioned inside the belt and facing the heater.

5. The fusing apparatus of claim 1, wherein the nip forming unit is connected to the heating unit and moves together with the heating unit in the forward and returning motions.

6. The fusing apparatus of claim 5, further comprising a bracket connected to a lateral portion of the nip forming unit and the heating unit,
wherein the nip forming unit is in a fixed position with respect to the bracket, and the heating unit is moveable with respect to the bracket in an elevation direction away from and toward the nip forming unit.

7. The fusing apparatus of claim 5, further comprising an elevation guide extending from the nip forming unit in an elevation direction of the heating unit such that the heating unit 100 is guided and supported by the elevating guide to elevate from and lower to the nip forming unit.

8. The fusing apparatus of claim 1, wherein the driving unit comprises:
a guidance member comprising a first trajectory corresponding to the forward motion and a second trajectory corresponding to the returning motion of the heating unit;
a first arm which rotates about a rotation axis as a rotation center; and
a second arm which is moveably engaged with the guidance member, fixedly connected to the heating unit, and coupled to the first arm so as to rotate in a radial direction of the first arm.

9. The fusing apparatus of claim 8, wherein the second arm moves along the first trajectory such that the heating unit moves forward at a constant speed.

10. The fusing apparatus of claim 1, wherein the driving unit comprises:
a first return spring which applies an elastic force to the heating unit in a direction in which the heating unit moves backward;
a first cam comprising:
a forward cam trajectory which moves the heating unit in a direction opposite to the direction of the elastic force of the first return spring to move the heating unit forward in the moving direction of the recording medium, through a first rotation angle of the first cam, and
a backward cam trajectory which moves the heating unit backward in the direction opposite to the moving direction of the recording medium, due to the elastic force of the first return spring, through a second rotation angle of the first cam;
a second return spring which applies an elastic force to the heating unit in a direction away from the nip forming unit; and
a second cam comprising:
a press cam trajectory which moves the heating unit toward the nip forming unit in a direction opposite to the direction of the elastic force of the second return spring so as to maintain the fusing nip, through a first rotation angle of the second cam, and
a release cam trajectory which moves the heating unit away from the nip forming unit to release the fusing nip, due to the elastic force of the second return spring, through a second rotation angle of the second cam,
wherein the first rotation angles and the second rotation angles are substantially the same.

11. The fusing apparatus of claim 10, wherein the backward cam trajectory of the first cam comprises first and second stop cam trajectories which maintain the heating unit at a constant position, at a beginning and an end of the backward cam trajectory.

12. The fusing apparatus of claim 1, wherein the heater comprises:
a resistance heating layer comprising:
a base polymer, and
an electrically conductive filler dispersed in the base polymer;
a member which supports the resistance heating layer; and
a current supplying electrode unit which supplies current to the resistance heating layer.

13. The fusing apparatus of claim 12, wherein the current flows in the resistance heating layer in the moving direction of the recording medium.

14. The fusing apparatus of claim 13, wherein
the current supplying electrode unit comprises a pair of electrodes elongated in a direction crossing the moving direction of the recoding medium, and spaced apart from each other in the moving direction of the recording medium.

15. The fusing apparatus of claim 12, wherein the heater further comprises a release layer which on the resistance heating layer, is an outermost layer of the heater and faces the nip forming unit.

16. The fusing apparatus of claim 15, wherein the heater further comprises an elastic layer between the resistance heating layer and the release layer.

17. A fusing method comprising:
preparing a heating unit comprising a heater which generates heat and has a substantially flat shape, and a nip forming unit comprising a nip former having a substantially flat shape;
forming a fusing nip between the heater and the nip forming unit by reducing a gap between the heating unit and the nip forming unit;
fusing a toner image on a recording medium passing through the fusing nip in a moving direction, by applying heat and pressure to the toner image while moving the heating unit in a forward motion in the moving direction;
releasing the fusing nip by increasing the gap between the heating unit and the nip forming unit; and
moving the heating unit in a backward motion in a direction opposite to the moving direction,
wherein the preparing, the forming, the fusing, the releasing and the moving are repeated.

18. The fusing method of claim 17, wherein the heater comprises a resistance heating layer comprising:
a base polymer, and
an electrically conductive filler dispersed in the base polymer.

19. The fusing method of claim 18, wherein
the applying heat and pressure to the toner image comprises supplying current flowing in the resistance heating layer, in the moving direction of the recording medium.

20. The fusing method of claim 19, wherein
the supplying current flowing in the resistance heating layer comprises:
arranging a pair of electrodes elongated in a direction crossing the moving direction of the recording medium, and spaced apart from each other in the moving direction of the recording medium; and
supplying the current to the pair of electrodes.
